(19) United States
(12) Patent Application Publication
(10) Pub. No.: US 2023/0420784 A1
(43) Pub. Date: Dec. 28, 2023

(54) BATTERY ASSEMBLY

(71) Applicant: Battery Graphene Corp Pty Ltd, Queensland (AU)

(72) Inventor: Dominic SPOONER, Queensland (AU)

(21) Appl. No.: 18/463,424

(22) Filed: Sep. 8, 2023

Related U.S. Application Data
(63) Continuation-in-part of application No. PCT/AU2022/050095, filed on Feb. 14, 2022.

(30) Foreign Application Priority Data
Mar. 10, 2021 (AU) 2021900673
Mar. 12, 2021 (AU) 2021101290
Dec. 17, 2021 (AU) 2021904117

(51) Int. Cl. H01M 50/264; H01M 50/213; H01M 50/258; H01M 50/588; H01M 50/59; H01M 10/653; H01M 50/522; H01M 50/227; H01M 50/229; H01M 50/222; H01M 50/296

(52) U.S. Cl. CPC H01M 50/264; H01M 50/213; H01M 50/258; H01M 50/588; H01M 50/59; H01M 10/653; H01M 50/522; H01M 50/227; H01M 50/229; H01M 50/222; H01M 50/296

(57) ABSTRACT

The present invention relates to a battery assembly including a casing, and battery modules received in the casing. The casing and the battery modules may be easily disassembled as they are not welded, and cells within the battery modules replaced during recycling. Similarly, during assembly, there is preferably no welding or deforming of parts.

### CROSS-REFERENCE TO RELATED APPLICATION

The present application is a continuation-in-part of PCT International Application No. PCT/AU2022/050095, filed Feb. 14, 2022, which claims priority to Australian Provisional Application No. 20211900673, filed Mar. 10, 2021, Australian Provisional Application No. 2021101290, filed Mar. 12, 2021, and Australian Provisional Application No. 2021904117, filed Dec. 17, 2021. Each of the foregoing applications is incorporated by reference herein in its entirety.

### TECHNICAL FIELD

The present invention relates to a battery assembly.

### BACKGROUND

The reference to any prior art in this specification is not, and should not be taken as an acknowledgement or any form of suggestion that the prior art forms part of the common general knowledge.

Battery clamshells are a type of battery assembly commonly used in electric vehicles. The clamshell includes batteries (or cells) with welded tabs at top and bottom. Plastic layers are provided to hold the batteries and a serpentine cooling system runs though the clamshell.

In practice, after expiry, the clamshells must be recycled although are difficult to disassemble.

The preferred embodiment provides a battery assembly for improved recycling.

### SUMMARY OF THE INVENTION

According to one aspect of the present invention, there is provided a battery assembly including:
a casing; and
battery modules received in the casing, each battery module further including:
   cells;
   posts extending from the cells;
   a receiver for receiving the posts; and
   a locking member for engaging with the received posts to lock the module together, wherein one or more of the receiver, posts and locking member are molded from electrically-insulative polymeric material to avoid short circuiting the cells, and include graphene to enhance thermal conductivity for heat sinking, and
   wherein the locking member is slid laterally to the posts along the receiver to engage with the posts.

The casing and the battery modules may be easily disassembled as they are not welded, and cells within the battery modules replaced during recycling. Similarly, during assembly, there is preferably no welding or deforming of parts.

The casing may include an outer shell, and an internal current collector within the shell for engaging with the battery modules. The shell may include a thermally conductive polymer. The shell may include graphene. The shell may be electrically insulating. The current collector may include metal and/or graphene.

The battery modules may be arranged in the casing to form a pattern, such as a grid pattern. The battery modules may define complementary formations at either end to facilitate a complementary fit between adjacent modules. The battery modules may engage with the casing which sinks heat from the battery modules.

Each module may include a plurality of cells. Each module may include a pair of retainers for retaining the cells. Each retainer may include a plate, and supports extending from the plate and for supporting the cells. The supports may include posts. The supports may, or may not, be spaced equidistantly to provide for equal distancing of the cells. The supports may surround terminals for engaging with the cells.

The assembly may further include another casing or lid for fastening to the casing to encase the battery modules. The assembly may further include fasteners for fastening the casings together. The fasteners may include snap-fit fasteners or threaded fasteners, and advantageously the assembly does not require welding.

According to some embodiments of the present invention, there is provided a battery module for a battery assembly, the battery module including:
a base from which supports for supporting cells extend.

The supports may include ribs for extending between the cells.

Advantageously, the locking member may require less pressure to lock the module together and may be easier to release than snap fit arrangements (e.g. PCT/AU2020/050604), without the need for screws or other threaded fasteners.

The locking member may define apertures through which respective posts pass. The locking member may engage with the posts using a tongue-in-hole arrangement. The locking member may be slid along the receiver to engage the tongue-in-hole arrangement for locking. The locking member may define tongues in the apertures which engage within holes in the posts.

The receiver may define apertures through which respective posts are received. The receiver may include an insulator plate.

The module may include couplers for electrically coupling the cells together. Each coupler may include a metal strip. The module may include terminals for terminating the coupled cells.

The battery module may further include a base. The base may include an insulator. The base may define recesses for receiving the cells. The base may include ribs for extending between the cells. The posts may extend from the base. The posts may be welded to the base.

Any one or more of the electrically conductive components of the module may include metal and graphene.

According to some embodiments of the present invention, there is provided a method for assembling a battery assembly, the method involving:
assembling battery modules including cells; and
assembling the battery assembly encasing the battery modules.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a perspective view of a battery assembly in accordance with an embodiment of the present invention;

FIG. 2 is a partially exploded perspective view of a battery module of the battery assembly of FIG. 1;

FIG. 3 is an exploded perspective view of a battery module in accordance with another embodiment;

FIG. 4 is an assembled perspective view of the battery module of FIG. 3;

FIG. 5 is a partially exploded perspective view of four battery modules of FIG. 3 for being received in a battery assembly;

FIG. 6 is a partially exploded perspective view of six battery modules module in accordance with yet another embodiment; and

FIG. 7 is an assembled perspective view of a battery module of FIG. 6.

### DETAILED DESCRIPTION OF PREFERRED EMBODIMENTS

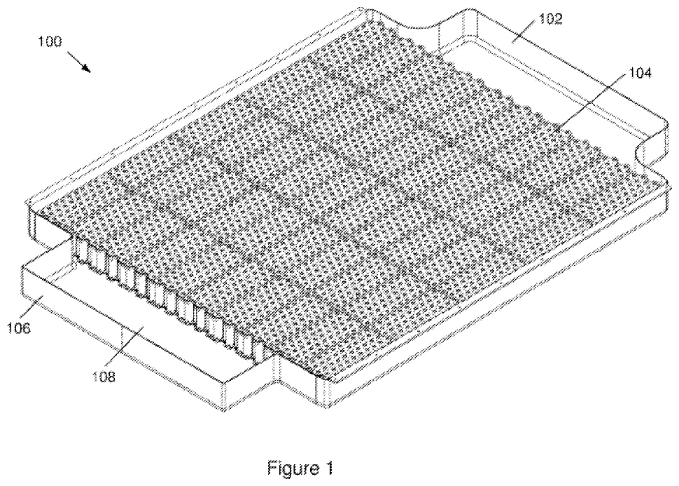

According to an embodiment of the present invention, there is provided a battery assembly 100 as shown in FIG. 1. The assembly 100 includes a casing 102, and battery modules 104 received to sit in the casing 102.

The assembly 100 can be easily disassembled, and the battery modules 104 or constituent cells replaced during recycling.

The casing 102 includes an outer shell 106, and an internal current collector 108 applied as a coating within the shell 106 for engaging with the battery modules 104. The shell 106 is molded from a thermally conductive polymer, and can include graphene and other compositions to be electrically insulating. The current collector 108 is electrically conductive, and includes metal and/or graphene. The current collector 108 can configure the battery modules 104 to be connected in parallel or series.

The battery modules 104 are arranged in the casing 102 to form a pattern. The assembly 100 further includes another casing or lid (not shown) for fastening to the casing 102 to encase the battery modules 104 and hold them in place. As before, the other casing or lid also includes an outer shell, and an internal current collector applied to the shell 106 for engaging with the battery modules 104. The battery modules 104 engage with the casing 102 which sinks heat from the battery modules 104.

The assembly 100 further includes fasteners for fastening the casings together. The fasteners can include molded and resilient snap-fit fasteners, or threaded screw fasteners, and advantageously the assembly does not require welding.

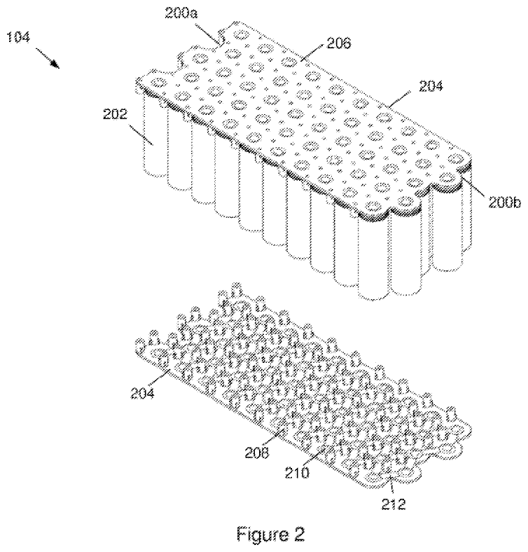

As can best be seen in FIG. 2, the battery modules 104 define complementary tongue-and-hole formations 200a, 200b at either end to facilitate a complementary fit between adjacent modules 104, for facilitating alignment and preventing lateral displacement.

Each module includes 104 a plurality of cylindrical battery cells 202 arranged in a grid. Each module 104 includes a pair of retainers 204 for sandwiching and retaining the upright cells 202. Each retainer 204 includes a conductive outer base plate 206 in electrical contact with the current collector 108, and post supports 208 extending from the plate 206 and for supporting the upright cells 202. The insulator supports 208 are typically spaced equidistantly to provide for equal distancing of the cells 202. The supports 208 surround electrical terminals 210 for engaging with the cells 202. The terminals 210 are molded into bumps to promote electrical contact with the cells 202.

Each retainer 204 includes an inner insulator from which the posts 208 extend, and an internal latticed current collector 212 applied as a coating to the insulator for interconnecting the terminals 210. The terminals 210 are in electrical connection with the conductive base plate 206. Once again, the assembly 100 further includes fasteners for fastening the retainers 204 together. The fasteners can include molded and resilient snap-fit fasteners, or threaded screw fasteners, and advantageously the assembly 100 does not require welding.

A method for assembling the battery assembly 100 is briefly described.

First, the battery modules 104 including the cells 202 are assembled. The cells 202 are located in register with the terminals 210 of a retainer 204. Once the cells 202 are in place, the retainers 204 are fastened together.

Next, the battery assembly 100 encasing the battery modules 104 is assembled. The battery modules 104 are laid in an interlocking manner to form a grid in the casing 102. The lid or other casing is then fastened to the casing 102 to snugly encase the battery modules 104 in place.

The reverse steps can be readily performed during recycling to replace the cells 202 as there is no welding of or deforming of parts.

The battery assembly 100 provides for weld free battery assembly, and does not affect the structure of the cells 202. This means the assembly 100 can be easily disassembled and cells 202 replaced, more easily recycled or reused in other applications. The battery assembly 100 provides for quicker, easier assembly with less parts. The thermally conductive material that is electrically insulating is used to form the outer shell 106, enables simpler design to avoid short circuiting the cells 202. The battery assembly 100 is safer to assemble and maintain, has reduced weight and size and allows for any type of liquid cooling system.

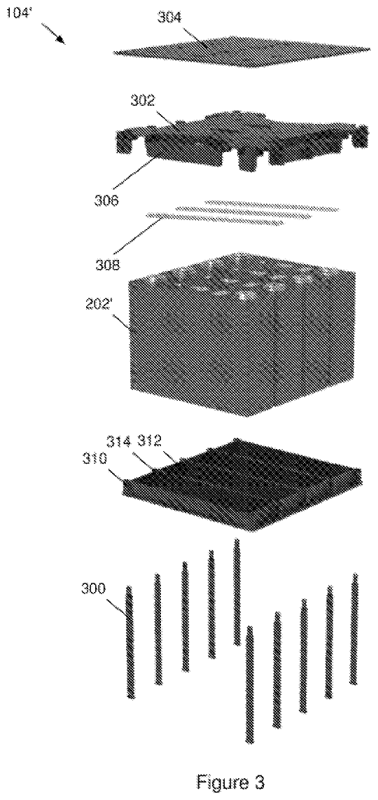

FIG. 3 shows an alternative battery module 104′ for the battery assembly 100. The battery module 104′ is of similar construction to that of AU2021101290, which is incorporated herein by reference.

The module 104′ includes box-like cells 202′. Posts 300 extend along and up from the cells 202′. A plate receiver 302 is provided for receiving the top ends of the posts 300. A locking plate 304 (i.e. member) is also provided for engaging with the received posts 300 to lock the module 104′ together.

Advantageously, the locking plate 304 may require less pressure to lock the module 104′ together and may be easier to release than snap fit arrangements (e.g. PCT/AU2020/050604), without the need for screws or other threaded fasteners.

The locking plate 304 defines apertures through which respective posts 300 pass. The locking plate 304 engages with the posts 300 using a tongue-in-hole arrangement. In particular, the locking plate 304 is slid along the adjacent plate receiver 302 to engage the tongue-in-hole arrangement for locking. The locking plate 304 defines tongues in the apertures which engage within holes in the posts 300.

The plate receiver 302 also defines apertures through which respective posts 300 are received. The receiver 302 is an insulator plate with peripheral retainer tabs 306 to retain the tops of the cells 202′.

The module 104′ also includes couplers 308 for electrically coupling the cells 202′ together in series. Each coupler 308 includes a metal strip for coupling at both ends and to terminals of respective cells 202′.

The battery module 104′ further includes an insulator base 310. The base 310 defines recesses 312 for receiving respective cells 202′. The base recesses 312 are separated by partitioning ribs 314 that extending between the cells 202′. The posts 300 are inserted through the underside of the base 310.

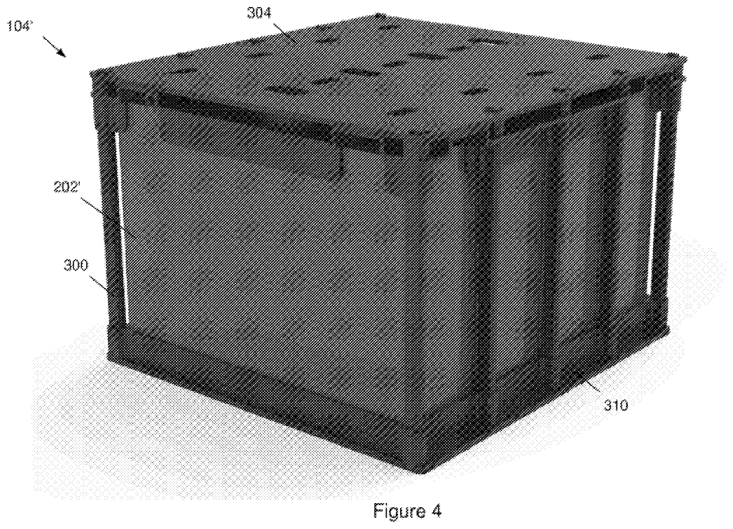

Turing to FIG. 4, the posts 300 are received in, and extend from the base 310. The posts 300 may be welded to the base 310.

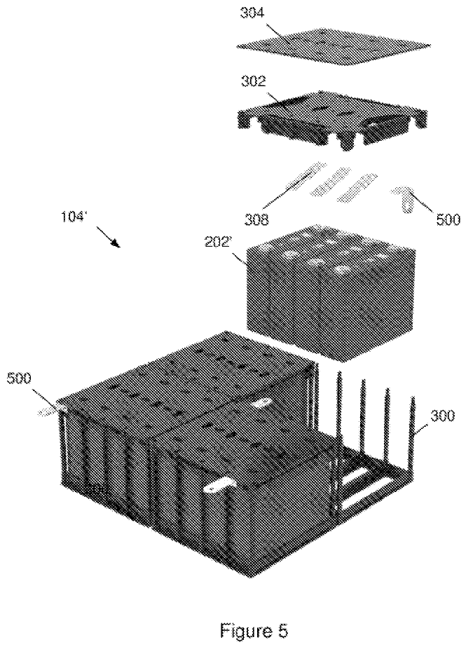

Turing to FIG. 5, the battery modules 104′ are electrically interconnected when received in a casing 102 of the battery assembly 100. To this end, electrical conductor tabs 500 in connection with the cells 202′, extend from the modules 104′ and are coupled to conductor tabs 500 of adjacent modules 104′.

The electrical insulator plate receiver 302, base 310, resilient posts 300 and locking plate 304 are molded from polymeric material to avoid short circuiting the cells 102′, and include graphene and/or carbon fibre to enhance thermal conductivity for heat sinking. The electrically conductive couplers 308 and tabs 500 include metal and graphene.

The grid of battery modules 104′ can be snugly encased withing the thermally conductive casing 102, without the need for the current collector 108, which helps to cool the cells 102′ and to form a secure battery pack.

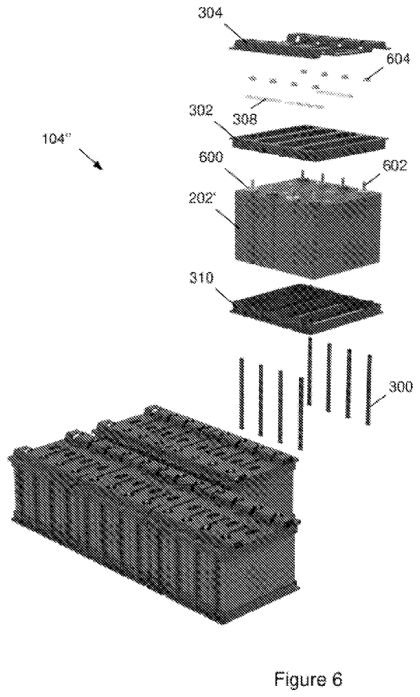

FIG. 6 shows yet an alternative battery module 104″ for the battery assembly 100. The battery module 104″ is similar to battery module 104′ previously described.

The terminals 600 of respective cells 202′ include threaded shafts 602 which pass through holes of the strip couplers 308. Nuts 604 are threaded onto the shafts 602 to securely fasten the strip couplers 308.

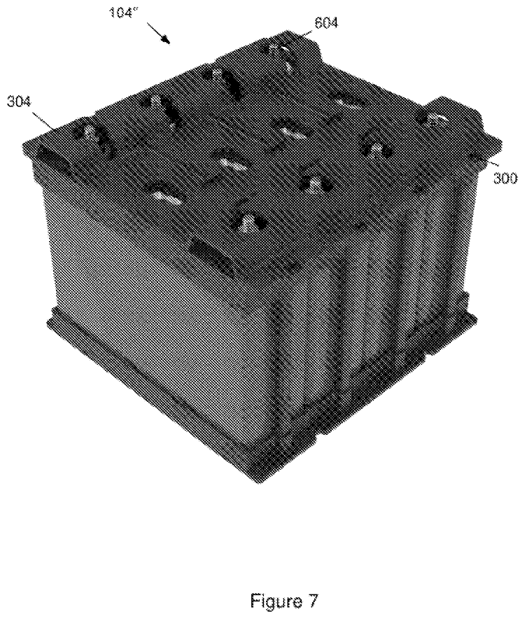

As can best be seen in FIG. 7, the locking plate 304 has apertures to provide access to the nuts 604.

A person skilled in the art will appreciate that many embodiments and variations can be made without departing from the ambit of the present invention.

In one embodiment, the current collector 108 may be a separate layer, instead of being applied as a coating.

In one embodiment, the locking member 304 forms a snap-fit with the posts 300 to lock the module 104′ together.

In compliance with the statute, the invention has been described in language more or less specific to structural or methodical features. It is to be understood that the invention is not limited to specific features shown or described since the means herein described comprises preferred forms of putting the invention into effect.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

What is claimed is:

1. A battery assembly, comprising:
a casing; and
battery modules received in the casing, each battery module further including:
cells;
posts extending from the cells;
a receiver for receiving the posts; and
a locking member for engaging with the received posts to lock the module together, wherein one or more of the receiver, posts and locking member are molded from electrically-insulative polymeric material to avoid short circuiting the cells, and include graphene to enhance thermal conductivity for heat sinking, and
wherein the locking member is slid laterally to the posts along the receiver to engage with the posts.

2. The battery assembly as claimed in claim 1, wherein the casing and the battery modules are disassemblable as they are not welded, and cells within the battery modules replaced during recycling.

3. The battery assembly as claimed in claim 1 wherein, during assembly, there is no welding or deforming of the casing or battery modules.

4. The battery assembly as claimed in claim 1, wherein the casing includes an outer shell, and an internal current collector within the shell for engaging with the battery modules.

5. The battery assembly as claimed in claim 4, wherein the shell includes a thermally conductive polymer and/or graphene.

6. The battery assembly as claimed in claim 4, wherein the current collector includes metal and/or graphene.

7. The battery assembly as claimed in claim 1, wherein each of the battery modules includes a plurality of cells, and a pair of retainers for retaining the cells.

8. The battery assembly as claimed in claim 1, further comprising another part for fastening to the casing to encase the battery modules.

9. The battery assembly as claimed in claim 8, further comprising fasteners for fastening the casing and part together, the fasteners including snap-fit fasteners or threaded fasteners, and advantageously the assembly does not require welding.

10. The battery assembly as claimed in claim 1, wherein each battery module includes a base from which supports for supporting cells extend.

11. The battery assembly as claimed in claim 1, wherein the receiver defines apertures through which respective posts are received.

12. The battery assembly as claimed in claim 1, wherein the locking member engages with the posts using a tongue-in-hole arrangement.

13. The battery assembly as claimed in claim 1, wherein each battery module includes couplers for electrically coupling cells together.

14. The battery assembly as claimed in claim 13, wherein each module includes terminals for terminating the coupled cells and interconnecting with adjacent battery modules.

15. The battery assembly as claimed in claim 14, wherein any one or more of the electrically conductive couplers or terminals include metal and graphene.

16. The battery assembly as claimed in claim 1, wherein the battery modules are arranged in the casing to form a pattern and engage with the casing which sinks heat from the battery modules.

17. A method for assembling a battery assembly as claimed in claim 1, the method comprising:
assembling battery modules including cells; and
assembling the battery assembly encasing the battery modules.

18. A battery module for a battery assembly as claimed in claim 1, the battery module comprising:
a base from which supports for supporting cells extend.
